(19) United States
(12) Patent Application Publication
(10) Pub. No.: US 2026/0128582 A1
(43) Pub. Date: May 7, 2026

(54) A Short-Circuit Protection Circuit, Controller, and Vehicle

(71) Applicant: Robert Bosch GmbH, Stuttgart (DE)

(72) Inventors: Xiaofei Qiu, Suzhou (CN); Bo Yuan, Suzhou (CN); Yiqun Huang, Suzhou (CN); Bingqing Lin, Suzhou (CN); Lue Shen, Suzhou (CN)

(21) Appl. No.: 19/374,240

(22) Filed: Oct. 30, 2025

(30) Foreign Application Priority Data
Nov. 4, 2024 (CN) 2024 1156 4117.2

(51) Int. Cl. H02H 9/02

(52) U.S. Cl. CPC H02H 9/02

(57) ABSTRACT

A short-circuit protection circuit, controller, and vehicle are disclosed. The short-circuit protection circuit includes a current detection circuit, comparator circuit, switch circuit, and latch circuit. The current detection circuit is configured to generate a target voltage according to a target current flowing from a first node to a second node and provide the target voltage to a third node. When a target current is greater than a short-circuit current threshold, the target voltage is higher than a reference voltage. The comparator circuit is configured to output a first level via a fourth node when a voltage of the third node is higher than a reference voltage. The switch circuit is configured to disconnect the first node and the second node when the fourth node is at the first level. The latch circuit is configured to maintain a voltage of the third node higher than a reference voltage when the fourth node is at the first level. This short-circuit protection circuit can disconnect the loop when a short circuit occurs in the loop in which the circuit is located, thereby protecting the safety of other components in the loop.

This application claims priority under 35 U.S.C. § 119 to application no. CN 2024 1156 4117.2, filed on Nov. 4, 2024 in China, the disclosure of which is incorporated herein by reference in its entirety.

The examples of the present disclosure relate generally to the technical field of circuitry, and in particular to a short-circuit protection circuit, controller, and vehicle.

### BACKGROUND

A short circuit occurs when a circuit or part of a circuit is shorted. During a short circuit, the current provided by the power supply will be much greater than the current provided under normal circumstances, which may burn out the power supply or device.

### SUMMARY

Examples of the present disclosure provide a short-circuit protection circuit, controller, and vehicle. According to a first aspect of the present disclosure, a short-circuit protection circuit is provided. The short-circuit protection circuit comprises: a current detection circuit, comparator circuit, switch circuit, and latch circuit. The current detection circuit is configured to generate a target voltage according to a target current flowing from a first node to a second node and provide the target voltage to a third node. When a target current is greater than a short-circuit current threshold, the target voltage is higher than a reference voltage. The comparator circuit is configured to output a first level via a fourth node when a voltage of the third node is higher than a reference voltage. The switch circuit is configured to disconnect the first node and the second node when the fourth node is at the first level. The latch circuit is configured to maintain a voltage of the third node higher than a reference voltage when the fourth node is at the first level.

According to a second aspect of the present disclosure, a controller is provided. The controller comprises: a short-circuit protection circuit according to the first aspect of the present disclosure. A first node is coupled to the ground of an interface circuit in the controller and a second node is coupled to the external ground.

According to a third aspect of the present disclosure, a vehicle is provided. The vehicle comprises a controller according to the second aspect of the present disclosure.

### BRIEF DESCRIPTION OF THE DRAWINGS

The exemplary examples of the present disclosure will be described in further detail in conjunction with accompanying drawings in order to further clarify the above-mentioned and other objectives, features, and advantages of the present disclosure, wherein in the exemplary examples of the present disclosure, the same reference number typically represents the same part.

FIG. 1 illustrates a schematic diagram of an exemplary environment in which a short-circuit protection circuit according to an example of the present disclosure may be implemented;

FIG. 2 illustrates a schematic block diagram of a short-circuit protection circuit according to an example of the present disclosure;

FIG. 3 illustrates further schematic block diagram of a short-circuit protection circuit according to an example of the present disclosure;

FIG. 4 illustrates a schematic circuit diagram of a short-circuit protection circuit according to an example of the present disclosure; and

FIG. 5 illustrates another schematic circuit diagram of a short-circuit protection circuit according to an example of the present disclosure.

In the various accompanying drawings, the same or corresponding numbers represent the same or corresponding portions. It is to be noted that the elements in the figures are schematic and not to scale.

### DETAILED DESCRIPTION

The examples of the present disclosure will be described in further detail below with reference to the accompanying drawings. While certain examples of the present disclosure are shown in the accompanying drawings, it should be understood that the present disclosure may be implemented in various forms and should not be construed as being limited to the examples set forth herein, rather these examples are provided for a more thorough and complete understanding of the present disclosure. It should be understood that the accompanying drawings and examples of the present disclosure are for exemplary purposes only and are not intended to limit the scope of protection of the present disclosure.

In the description of the examples of the present disclosure, the term “comprise” and other similar expressions should be understood as open-ended inclusion, that is, “comprising but not limited to.” The term “based on” should be understood as “at least partially based on.” The term “one example” or “this example” should be understood as “at least one example.” The terms “first,” “second,” etc. may refer to different objects or the same object. The text below may comprise other specific and implicit meanings.

Unless defined otherwise, all terms used herein (including technical and scientific terms) have the same meaning as commonly understood by those skilled in the art to whom the present subject matter is directed. It will further be understood that terms such as those defined in commonly-used dictionaries should be construed as having meanings consistent with their meaning in the context of the specification and relevant techniques and will not be construed in an idealized or overly formal form unless otherwise expressly defined herein. As used herein, a representation that two or more portions are “connected” or “coupled” together shall refer to the incorporation of those portions directly together or through at least one intermediate component.

As noted above, during a short circuit, the current provided by the power supply will be much greater than the current provided under normal circumstances, which may damage the power supply or device. Therefore, a short-circuit protection circuit can be designed in the loop to protect the loop in the event of a short circuit. Examples of the present disclosure provides a short-circuit protection circuit.

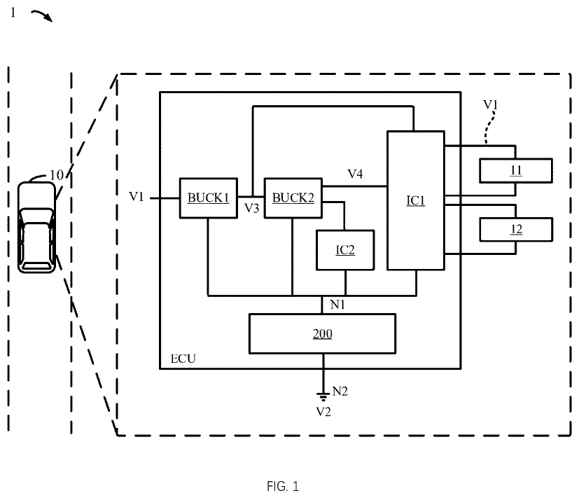

Examples of the present disclosure will be described in further detail below in conjunction with the accompanying drawings, wherein FIG. 1 illustrates an exemplary environment in which the short-circuit protection circuit according to the examples of the present disclosure may be implemented.

As shown in FIG. 1, the exemplary environment 1 comprises a vehicle 10. An electronic control unit (ECU), an ignition circuit 11, and other input and output circuits 12 may be provided in the vehicle 10. An input voltage V1 (e.g., 48 V) of the ECU may be bucked to a voltage V3 (e.g., 33V) via a first buck converter BUCK1. The voltage V3 may serve as the power supply voltage of an interface chip IC1. The voltage V3 may be bucked to a voltage V4 (e.g., 3.3V) via a second buck converter BUCK2. The voltage V4 may serve as the power supply voltage of the interface chip IC1 and a power supply voltage for other chips IC2. The first buck converter BUCK1, a second buck converter BUCK2, the interface chip IC1, and the other chips IC2 may be collectively connected to a first node N1.

The interface chip IC1 may connect the ignition circuit 11 and other input/output circuits 12 via a harness. As the harness wears out or in the event of a vehicle collision, the interface chip IC1 may be shorted to the input voltage V1. Since the power supply voltage that the interface chip IC1 is capable of bearing is lower than the input voltage V1, the interface chip IC1 may be burned when the interface chip IC1 is shorted to the input voltage V1.

In some examples, a Zener diode may be added to each harness connected to the first node N1 to protect the components on the corresponding harness from damage when the interface chip IC1 is shorted to the input voltage V1. However, the Zener diode itself may be damaged, which causes the functional level of the ECU to become Failure Severity Classification (FSC) Class D, and at FSC Class D, the component is damaged and irrecoverable. Also, hardware costs are higher due to the need to add a Zener diode to each harness. Accordingly, the area of the printed circuit board (PCB) will also be larger due to the need to add a large number of Zener diodes.

Referring to FIG. 1, an example of the present disclosure proposes a short-circuit protection circuit 200 disposed between the first node N1 and the ground (second node N2). The short-circuit protection circuit 200 is configured to disconnect the first node N1 and the ground (second node N2) in the event of a short circuit such that the loop between the interface chip IC1 and the ground is disconnected, thereby preventing the interface chip IC1 from being burned out.

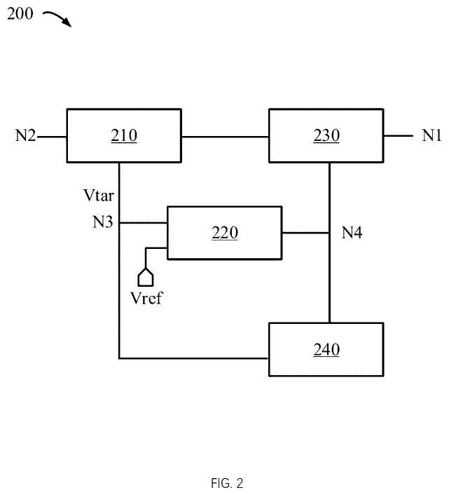

FIG. 2 illustrates a schematic block diagram of a short-circuit protection circuit 200 according to examples of the present disclosure; The short-circuit protection circuit 200 comprises: a current detection circuit 210, a comparator circuit 220, a switch circuit 230, and a latch circuit 240. The current detection circuit 210 and the switch circuit 230 are connected in series between the first node N1 and the second node N2.

The current detection circuit 210 is coupled to the second node N2 and the switch circuit 230. The current detection circuit 210 is further coupled the input terminal of the comparator circuit 220 and the latch circuit 240 via a third node N3. The current detection circuit 210 is configured to generate a target voltage Vtar according to a target current flowing from the first node N1 to the second node N2 and provide the target voltage Vtar to the third node N3. When the target current is greater than a short-circuit current threshold, the target voltage Vtar is higher than a reference voltage Vref. The target voltage Vtar is lower than the reference voltage Vref when the target current is less than the short-circuit current threshold. The target voltage Vtar is equal to the reference voltage Vref when the target current is equal to the short-circuit current threshold. In the event that the connection between the first node N1 and the second node N2 is disconnected, the target current is zero and the target voltage Vtar is also zero.

The comparator circuit 220 is coupled to the current detection circuit 210 via the third node N3 to obtain the target voltage Vtar generated by the current detection circuit 210. The comparator circuit 220 is further coupled to a reference voltage terminal to obtain the reference voltage Vref from the reference voltage terminal. The comparator circuit 220 is coupled to the switch circuit 230 and latch circuit 240 via a fourth node N4. The comparator circuit 220 is configured to output a first level via the fourth node N4 when the voltage of the third node N3 is higher than the reference voltage Vref. The comparator circuit 220 is further configured to output a second level via the fourth node N4 when the voltage of the third node N3 is lower than the reference voltage Vref. In some examples of the present disclosure, the comparator circuit 220 outputs the first level via the fourth node N4 when the voltage of the third node N3 is equal to the reference voltage Vref. Alternatively, in some other examples of the present disclosure, the comparator circuit 220 outputs the second level via the fourth node N4 when the voltage of the third node N3 is equal to the reference voltage Vref. The output voltage of the comparator circuit 220 is provided to the switch circuit 230 and the latch circuit 240.

The switch circuit 230 is coupled to the first node N1 and the current detection circuit 210. The switch circuit 230 is further coupled to the comparator circuit 220 and latch circuit 240 via a fourth node N4. The switch circuit 230 is configured to disconnect the first node N1 and the second node N2 when the fourth node N4 is at the first level. The switch circuit 230 is further configured to connect the first node N1 and the second node N2 when the fourth note N4 is at the second level.

The latch circuit 240 is coupled to the input terminals of the current detection circuit 210 and the comparator circuit 220 via the third node N3. The latch circuit 240 is further coupled to the output terminals of the switch circuit 230 and the comparator circuit 220 via the fourth node N4. The latch circuit 240 is configured to maintain the voltage of the third node N3 higher than the reference voltage Vref when the fourth node N4 is at the first level. The latch circuit 240 is further configured to stop operating when the fourth node N4 is at the second level to not affect the voltage of the third node N3.

In some examples of the present disclosure, the first level is a low level and the second level is a high level. It should be noted that in this context, high level and low level are relative. The reference voltage Vref may be set based on the proportional relationship between the target current and the target voltage Vtar as well as a short-circuit current threshold.

The first node N1 and the second node N2 are initially connected. The target current flowing from the first node N1 to the second node N2 is less than the short-circuit current threshold when the interface chip IC1 in FIG. 1 is operating normally. The target voltage Vtar generated by the current detection circuit 210 is lower than the reference voltage Vref. Thus, the voltage of the third node N3 is lower than the reference voltage Vref. The comparator circuit 220 outputs the second level. In this case, the switch circuit 230 maintains the connection between first node N1 and second node N2 and the latch circuit 240 does not affect the voltage of the third node N3.

In the case where the interface chip IC1 in FIG. 1 is shorted to the input voltage V1, the target current flowing from the first node N1 to the second node N2 is greater than the short-circuit current threshold. The target voltage Vtar generated by the current detection circuit 210 is higher than the reference voltage Vref. Thus, the voltage of the third node N3 is higher than the reference voltage Vref. The comparator circuit 220 outputs the first level. In this case, the switch circuit 230 disconnects the first node N1 and the second node N2 and the latch circuit 240 maintains the voltage of the third node N3 higher than the reference voltage Vref. In this way, the comparator circuit 220 stably outputs the first level so that the switch circuit 230 keeps the connection between the first node N1 and the second node N2 disconnected.

The short-circuit protection circuit 200 of the examples of the present disclosure can disconnect the loop when a short circuit occurs in the loop in which the circuit is located, thereby protecting the safety of other components in the loop. Moreover, the short-circuit protection circuit 200 is able to maintain the open circuit state of the loop through the latch circuit 240, thereby preventing the circuit state from oscillating back and forth between short circuit and open circuit. Examples of the present disclosure are able to significantly reduce hardware costs, save PCB area, and enable the functional level of the ECU to reach FSC Class C relative to implementations using a Zener diode. In FSC Class C, there is no damage to components and a power cycle is required to restore function.

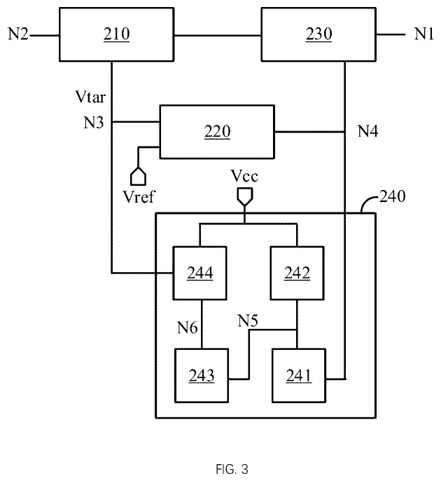

FIG. 3 illustrates a further schematic block diagram of a short-circuit protection circuit 200 according to examples of the present disclosure. As shown in FIG. 3, the latch circuit 240 comprises: a pull-down 241, a pull-up circuit 242, a first control circuit 243, and a second control circuit 244.

The pull-down circuit 241 is coupled to the output terminal of the comparator circuit 220 and the switch circuit 230 via the fourth node N4. The pull-down circuit 241 is further coupled to the pull-up circuit 242 and the first control circuit 243 via a fifth node N5. The pull-down circuit 241 is configured to pull down the voltage of the fifth node N5 to the first level when the fourth node N4 is at the second level. The pull-down circuit 241 is further configured to not affect the voltage of the fifth node N5 when the fourth node N4 is at the first level.

The pull-up circuit 242 is coupled to a power supply voltage terminal Vcc. The pull-up circuit 242 is further coupled to the pull-down circuit 241 and the first control circuit 243 via the fifth node N5. The pull-up circuit 242 is configured to pull up the voltage of the fifth node N5 to the second level when the fourth node N4 is at the first level. The second level may be equal to the power supply voltage from the power supply voltage terminal Vcc.

The first control circuit 243 is coupled to the pull-down circuit 241 and the pull-up path 242 via the fifth node N5. The first control circuit 243 is also coupled to the second control circuit 244 via a sixth node N6. The first control circuit 243 is configured to pull down the voltage of the sixth node N6 to the first level when the voltage of the fifth node N5 is at the second level. The first control circuit 243 is further configured to stop operating when the voltage of the fifth node N5 is at the first level so as not to affect the voltage of the sixth node N6.

The second control circuit 244 is coupled to the power supply voltage terminal Vcc. The second control circuit 244 is coupled to the first control circuit 243 via the sixth node N6. The second control circuit 244 is coupled to the input terminals of the current detection circuit 210 and the comparator circuit 220 via the third node N3. The second control circuit 244 is configured to pull up the voltage of the third node N3 to the second level when the voltage of the sixth node N6 is at the first level and to stop operating in other cases (when the voltage of the sixth node N6 is not at the first level) so as not to affect the voltage of the third node N3. Here, the second level is higher than the reference voltage Vref.

The first node N1 and the second node N2 are initially connected. The target current flowing from the first node N1 to the second node N2 is less than the short-circuit current threshold when the interface chip IC1 in FIG. 1 is operating normally. The target voltage Vtar generated by the current detection circuit 210 is lower than the reference voltage Vref. Thus, the voltage of the third node N3 is lower than the reference voltage Vref. The comparator circuit 220 outputs the second level. In this case, the switch circuit 230 maintains the connection between the first node N1 and the second node N2. Since the fourth node N4 is at the second level, the pull-down circuit 241 pulls down the voltage of the fifth node N5 to the first level. The first control circuit 243 stops operating. The second control circuit 244 also stops operating. Therefore, the latch circuit 240 does not affect the voltage of the third node N3.

In the case where the interface chip IC1 in FIG. 1 is shorted to the input voltage V1, the target current flowing from the first node N1 to the second node N2 is greater than the short-circuit current threshold. The target voltage Vtar generated by the current detection circuit 210 is higher than the reference voltage Vref. Thus, the voltage of the third node N3 is higher than the reference voltage Vref. The comparator circuit 220 outputs the first level. In this case, the switch circuit 230 disconnects the first node N1 and the second node N2. Since the fourth node N4 is at the first level, the pull-up circuit 242 pulls up the voltage of the fifth node N5 to the second level. The first control circuit 243 pulls down the voltage of the sixth node N6 to the first level. The second control circuit 244 pulls up the voltage of the third node N3 to the second level. In this way, the latch circuit 240 maintains the voltage of the third node N3 higher than the reference voltage Vref. Thus, the comparator circuit 220 can stably output the first level so that the switch circuit 230 keeps the connection between the first node N1 and the second node N2 disconnected.

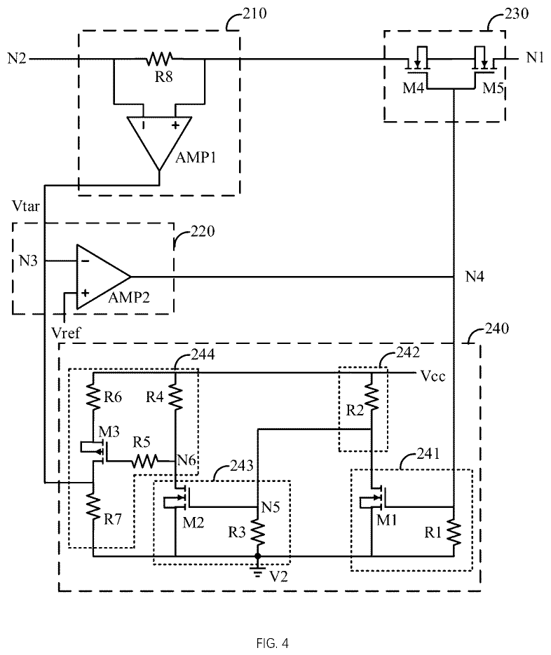

FIG. 4 illustrates a schematic circuit diagram of the short-circuit protection circuit 200 of FIG. 3. In the example of FIG. 4, the pull-down circuit 241 comprises a first resistor R1 and a first transistor M1. A first terminal of the first resistor R1 is coupled to the fourth node N4. A second terminal of the first resistor R1 is coupled to a second voltage terminal V2. A control electrode of the first transistor M1 is coupled to the first terminal of the first resistor R1. A first electrode of the first transistor M1 is coupled to the second voltage terminal V2. A second electrode of the first transistor M1 is coupled to the fifth node N5.

The pull-up circuit 242 comprises a second resistor R2. A first terminal of the second resistor R2 is coupled to the power supply voltage terminal Vcc. A second terminal of the second resistor R2 is coupled to the fifth node N5.

The first control circuit 243 comprises a third resistor R3 and a second transistor M2. A first terminal of the third resistor R3 is coupled to the fifth node N5. A second terminal of the third resistor R3 is coupled to the second voltage terminal V2. A control electrode of the second transistor M2 is coupled to the fifth node N5. A first electrode of the second transistor M2 is coupled to the second voltage terminal V2. A second electrode of the second transistor M2 is coupled to the sixth node N6.

The second control circuit 244 comprises a fourth resistor R4, a fifth resistor R5, a sixth resistor R6, a seventh resistor R7, and a third transistor M3. A first terminal of the fourth resistor R4 is coupled to the power supply voltage terminal Vcc. A second terminal of the fourth resistor R4 is coupled to the sixth node N6. A first terminal of the fifth resistor R5 is coupled to the sixth node N6. A second terminal of the fifth resistor R5 is coupled to a control electrode of the third transistor M3. A first terminal of the sixth resistor R6 is coupled to the power supply voltage terminal Vcc. A second terminal of the sixth resistor R6 is coupled to a first electrode of the third transistor M3. A first terminal of the seventh resistor R7 is coupled to a second electrode of the third transistor M3 and the third node N3. A second terminal of the seventh resistor R7 is coupled to the second voltage terminal V2.

The switch circuit 230 comprises a fourth transistor M4 and a fifth transistor M5. A control electrode of the fourth transistor M4 is coupled to the fourth node N4. A first electrode of the fourth transistor M4 is coupled to a first electrode of the fifth transistor M5. A second electrode of the fourth transistor M4 is coupled to the input terminal of the current detection circuit 210. A control electrode of the fifth transistor M5 is coupled to the fourth node N4. A second electrode of the fifth transistor M5 is coupled to the first node N1. The fourth transistor M4 and the fifth transistor M5 form a back-to-back structure, and the directions of their body diodes are opposite, which can prevent reverse current.

The current detection circuit 210 comprises an eighth resistor R8 and a first operational amplifier AMP1. A first terminal of the eighth resistor R8 is coupled to the second electrode of the fourth transistor M4. A second terminal of the eighth resistor R8 is coupled to the second node N2. A first input terminal of the first operational amplifier AMP1 is coupled to the first terminal of the eighth resistor R8. A second input terminal of the first operational amplifier AMP1 is coupled to the second terminal of the eighth resistor R8. An output terminal of the first operational amplifier AMP1 is coupled to the third node N3.

The comparator circuit 220 comprises a second operational amplifier AMP2. The reference voltage Vref is provided to a first input terminal of the second operational amplifier AMP2. A second input terminal of the second operational amplifier AMP2 is coupled to the third node N3. An output terminal of the second operational amplifier AMP2 is coupled to the fourth node N4.

In the example of FIG. 4, the first transistor M1, the second transistor M2, the fourth transistor M4, and the fifth transistor M5 are N-type transistors. The third transistor M3 is a P-type transistor. The second voltage terminal V2 is grounded. The first input terminal of the first operational amplifier AMP1 is an in-phase input terminal. The second input terminal of the first operational amplifier AMP1 is a reverse phase input terminal. The first input terminal of the second operational amplifier AMP2 is an in-phase input terminal. The second input terminal of the second operational amplifier AMP2 is a reverse phase input terminal. It will be understood by those skilled in the art that variations to the circuit shown in FIG. 4 based on the above-described inventive concepts should also fall within the protective scope of the present disclosure. In this variant, the voltage terminals described above may also have different settings than the example shown in FIG. 4.

Initially, the fourth transistor M4 and the fifth transistor M5 are turned on. The target current flowing from the first node N1 to the second node N2 is less than the short-circuit current threshold when the interface chip IC1 in FIG. 1 is operating normally. The voltage difference between the two terminals of the eighth resistor R8 is small, so the target voltage Vtar output by the first operational amplifier AMP1 is lower than the reference voltage Vref. At this point, the voltage of the third node N3 is lower than the reference voltage Vref, and thus the second operational amplifier AMP2 outputs the second level. In this case, the fourth transistor M4 and the fifth transistor M5 remain turned on. Since the fourth node N4 is at the second level, the first transistor M1 is turned on, which pulls down the voltage of the fifth node N5 to the first level. In this case, the second transistor M2 is turned off, thereby causing the third transistor M3 to turn off. Therefore, the latch circuit 240 does not affect the voltage of the third node N3.

In the case where the interface chip IC1 in FIG. 1 is shorted to the input voltage V1, the target current flowing from the first node N1 to the second node N2 is greater than the short-circuit current threshold. The voltage difference between the two terminals of the eighth resistor R8 increases, so the target voltage Vtar output by the first operational amplifier AMP1 is higher than the reference voltage Vref. At this point, the voltage of the third node N3 is higher than the reference voltage Vref, and thus the second operational amplifier AMP2 outputs the first level. In this case, the fourth transistor M4 and the fifth transistor M5 are turned off and the target current becomes zero. Since the fourth node N4 is at the first level, the first transistor M1 is turned off and the power supply voltage pulls up the voltage of the fifth node N5 to the second level via the second resistor R2. The second transistor M2 is turned on, thereby pulling down the voltage of the sixth node N6 to the first level. In this way, the third transistor M3 is turned on, thereby pulling up the voltage of the third node N3 to the second level. In the above manner, the latch circuit 240 maintains the voltage of the third node N3 higher than the reference voltage Vref. The second operational amplifier AMP2 is thus able to stably output the first level such that the fourth transistor M4 and the fifth transistor M5 remain turned off and the target current remains zero.

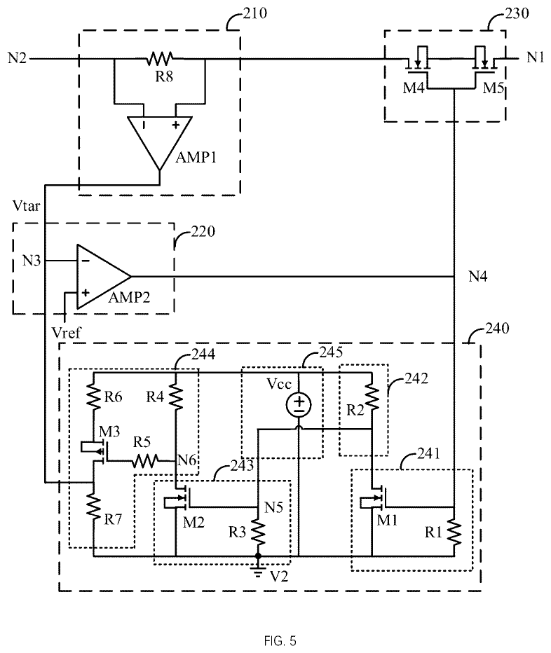

FIG. 5 illustrates another schematic circuit diagram of short-circuit protection circuit 200 according to examples of the present disclosure. On the foundation of FIG. 4, the latch circuit 240 further comprises a power supply circuit. The power supply circuit is configured to provide a power supply voltage to the pull-up circuit 242 and the second control circuit 244. In summary, the short-circuit protection circuit according to examples of the present disclosure can disconnect the loop when a short circuit occurs in the loop in which the circuit is located, thereby protecting the safety of other components in the loop. Moreover, the short-circuit protection circuit according to examples of the present disclosure is able to maintain the open circuit state of the loop through the latch circuit, thereby preventing the circuit state from oscillating back and forth between short circuit and open circuit. The short-circuit protection circuit according to the examples of the present disclosure has low hardware costs and occupies a small area.

The singular forms of the terms used herein and in the appended claims include the plural, and vice versa, unless the context clearly dictates otherwise. As such, when referring to the singular, it is common to include the plural of the respective terms. Where the term “example” is used herein, particularly when it follows a set of terms, the “example” is merely exemplary and illustrative and should not be considered exclusive or broad.

Further aspects and areas of applicability will become apparent from the description provided herein. It will be understood that various aspects of the present application may be implemented alone or in combination with at least one other aspect. It will also be understood that the description and specific examples herein are intended to be illustrative only and are not intended to limit the scope of the present application.

The various examples of the present disclosure have been described above. The descriptions provided are exemplary and not exhaustive, and they are also not limited to the disclosed examples. Many modifications and variations will be apparent to those skilled in the art without departing from the scope and spirit of the described examples. The selection of terms used in this text aims to best explain the principles and actual application of the various examples or the technological improvements in the market or to allow others skilled in the art to understand the various examples disclosed in this text.

What is claimed is:

1. A short-circuit protection circuit, comprising:
a current detection circuit configured to generate a target voltage according to a target current flowing from a first node to a second node and provide the target voltage to a third node, wherein when the target current is greater than a short-circuit current threshold, wherein the target voltage is higher than a reference voltage;
a comparator circuit configured to output a first level via a fourth node when the voltage of the third node is higher than the reference voltage;
a switch circuit configured to disconnect the first node and the second node when the fourth node is at the first level; and
a latch circuit configured to maintain the voltage of the third node higher than the reference voltage when the fourth node is at the first level.

2. The short-circuit protection circuit according to claim 1, wherein the target voltage is lower than the reference voltage when the target current is less than a short-circuit current threshold, the comparator circuit is further configured to output a second level via the fourth node when the voltage of the third node is lower than the reference voltage, and the switch circuit is further configured to connect the first node and the second node when the fourth node is at the second level.

3. The short-circuit protection circuit according to claim 2, wherein the latch circuit comprises:
a pull-down circuit configured to pull down the voltage of a fifth node to the first level when the fourth node is at the second level;
a pull-up circuit configured to pull up the voltage of the fifth node to the second level when the fourth node is at the first level;
a first control circuit configured to pull down the voltage of a sixth node to the first level when the voltage of the fifth node is at the second level; and
a second control circuit configured to pull up the voltage of the third node to the second level when the voltage of the sixth node is at the first level and to stop operating in other cases, wherein the second level is higher than the reference voltage.

4. The short-circuit protection circuit according to claim 3, wherein:
the pull-down circuit comprises a first resistor and a first transistor,
a first terminal of the first resistor is coupled to the fourth node and a second terminal of the first resistor is coupled to a second voltage terminal, and
a control electrode of the first transistor is coupled to the first terminal of the first resistor, a first electrode of the first transistor is coupled to the second voltage terminal, and a second electrode of the first transistor is coupled to the fifth node.

5. The short-circuit protection circuit according to claim 3, wherein:
the pull-up circuit comprises a second resistor, and
a first terminal of the second resistor is coupled to a power supply voltage terminal and a second terminal of the second resistor is coupled to the fifth node.

6. The short-circuit protection circuit according to claim 3, wherein:
the first control circuit comprises a third resistor and a second transistor,
a first terminal of the third resistor is coupled to the fifth node and a second terminal of the third resistor is coupled to a second voltage terminal, and
a control electrode of the second transistor is coupled to the fifth node, a first electrode of the second transistor is coupled to the second voltage terminal, and a second electrode of the second transistor is coupled to the sixth node.

7. The short-circuit protection circuit according to claim 3, wherein:
the second control circuit comprises a fourth resistor, a fifth resistor, a sixth resistor, a seventh resistor, and a third transistor,
a first terminal of the fourth resistor is coupled to the power supply voltage terminal and a second terminal of the fourth resistor is coupled to the sixth node,
a first terminal of the fifth resistor is coupled to the sixth node and a second terminal of the fifth resistor is coupled to a control electrode of the third transistor,
a first terminal of the sixth resistor is coupled to the power supply voltage terminal and a second terminal of the sixth resistor is coupled to a first electrode of the third transistor, and
a first terminal of the seventh resistor is coupled to a second electrode of the third transistor and the third node and a second terminal of the seventh resistor is coupled to a second voltage terminal.

8. The short-circuit protection circuit according to claim 3, wherein the latch circuit further comprises a power supply circuit configured to provide a power supply voltage to the pull-up circuit and the second control circuit.

9. The short-circuit protection circuit according to claim 1, wherein:
the switch circuit comprises a fourth transistor and a fifth transistor,
a control electrode of the fourth transistor is coupled to the fourth node, a first electrode of the fourth transistor is coupled to a first electrode of the fifth transistor, and a second electrode of the fourth transistor is coupled to an input terminal of the current detection circuit, and
a control electrode of the fifth transistor is coupled to the fourth node and a second electrode of the fifth transistor is coupled to the first node.

10. The short-circuit protection circuit according to claim 9, wherein:
the current detection circuit comprises an eighth resistor and a first operational amplifier,
a first terminal of the eighth resistor is coupled the second electrode of the fourth transistor and a second terminal of the eighth resistor is coupled to the second node, and
a first input terminal of the first operational amplifier is coupled to the first terminal of the eighth resistor, a second input terminal of the first operational amplifier is coupled to the second terminal of the eighth resistor, and an output terminal of the first operational amplifier is coupled to the third node.

11. The short-circuit protection circuit according to claim 1, wherein:
the comparator circuit comprises a second operational amplifier, and
a first input terminal of the second operational amplifier is provided with the reference voltage, a second input terminal of the second operational amplifier is coupled to the third node, and an output terminal of the second operational amplifier is coupled to the fourth node.

12. A controller comprising the short-circuit protection circuit according to claim 1, wherein:
the first node is coupled to a ground terminal of an interface circuit in the controller, and
the second node is coupled to an external ground terminal.

13. A vehicle comprising the controller according to claim 12.
